(19) United States
(12) Patent Application Publication
(10) Pub. No.: US 2002/0027421 A1
(43) Pub. Date: Mar. 7, 2002

(54) Mercury-free metal halide lamp

(76) Inventors: Yuriko Kaneko, Nara-shi (JP); Kiyoshi Takahashi, Hirakata-shi (JP); Hideaki Kiryu, Takatsuki-shi (JP); Masato Yoshida, Takatsuki-shi (JP)

Correspondence Address: HARNESS, DICKEY & PIERCE, PLC, P.O. BOX 828, BLOOMFIELD HILLS, MI, 48303, US

(21) Appl. No.: 09/903,357

(22) Filed: Jul. 11, 2001

(30) Foreign Application Priority Data
Jul. 14, 2000 (JP) 2000-214046

(51) Int. Cl. H01J 17/20

(52) U.S. Cl. 313/637

(57) ABSTRACT

A mercury-free metal halide lamp includes an arc tube having a pair of electrodes opposed to each other inside the tube. In the arc tube, a rare gas and a halide of cerium are contained, and no mercury is contained.

### BACKGROUND OF THE INVENTION

The present invention relates to mercury-free metal halide lamps. In particular, the present invention relates to lamps for a point-like light used in combination with a reflecting mirror.

As lamps for general illumination and headlights of automobiles, metal halide lamps enclosing a metal halide in an arc tube (bulb) are becoming increasingly popular. Conventional halide lamps include lamps having electrodes in the arc tube (hereinafter, referred to as “electrode-provided lamp”) and lamps having no electrodes (hereinafter, referred to as “electrodeless lamps”).

A specific example of conventional electrode-provided metal halide lamps is disclosed in Japanese Laid-Open Patent Publication No. 57-92747. The electrode-provided lamp disclosed in this publication includes a rare gas, mercury, sodium halide, and a halide of, for example, cerium in an arc tube. The publication describes that with this, a high emission efficiency and white light characteristics can be realized.

A specific example of conventional electrodeless metal halide lamps is disclosed in Japanese Laid-Open Patent Publication No. 1-132039. The electrodeless lamp disclosed in this publication includes sodium halide and cerium halide, and xenon in an arc tube. The publication describes that with this, the lamp can emit white light.

However, it was found that the conventional lamps have a problem in that the width of the arc is large. When the width of the arc is large, metal halide lamps that do not meet the standard may be produced. For example, in the metal halide lamps for headlights of automobiles, a standard is defined with respect to the width of the arc, and therefore, the width of the arc is required to meet the standard.

In the Japan Electric Lamp Manufacture Association, the Japan Electric Lamp Manufacture Association Standard of HID light sources for headlights of automobiles (JEL215) is defined. In this definition, the width of the arc between the positions at a value of 20% of the maximum intensity is defined as the width of the arc when the relative intensity distribution is measured in the cross-section of the center of the arc (central position between the electrodes), and the arc is required to be within 1.10 mm ±0.40 mm. This value is set as the standard for controlling light distribution when the lamp is incorporated in a lighting fixture.

Japanese Laid-Open Patent Publication No. 57-92747 describes that an electrode-provided lamp including a rare gas, mercury, and a halide of sodium (Na), a halide of cerium (Ce) can realize a stable discharge arc having a large width. Then, the inventors of the present invention produced a lamp according to this publication. In the produced lamp, 0.65 mg of mercury, 0.16 mg of sodium halide, and 0.2 mg of cerium halide were enclosed in an arc tube with an inner volume of 0.025 cc. When this lamp is turned on at a power consumption of 35 W, the width of the arc was 1.8 mm. This is outside the standard to a large extent. In other words, there is a problem in that the electrode-provided metal halide lamp including a halide of cerium and mercury results in the arc having a large width.

The electrodeless lamps disclosed in Japanese Laid-Open Patent Publication No. 1-132039 has a problem in that the arc is spread throughout the arc tube. This is a feature inherent in electrodeless lamps, and the size of the arc tube corresponds exactly to the size of the arc. Although there are many attempts to reduce the size of the arc tube, it is difficult to reduce the size of the arc tube because of lamp damage or other problems, and these attempts are not successful at the moment. For example, the experiments conducted by the inventors of the present invention confirmed the following. When energy in the same amount as that supplied to the arc tube disclosed in the publication is supplied to a smaller arc tube than that disclosed in the publication, the temperature of the arc tube is increased. As a result, the lamp is broken in several hours after it turns on. Therefore, the electrodeless metal halide lamp has a problem in that it cannot be used when a light source close to a point light source is desired in order to combine with a reflecting mirror or the like.

In these days, environmental issues are attracting people's attention, so that a metal halide lamp containing no mercury is desired in view of the environmental protection of the earth when it is disposed of. The above-described electrodeless lamp disclosed in Japanese Laid-Open Patent Publication No. 1-132039 is a mercury-free metal halide lamp, but as described above, it is difficult to realize a point-like light source because this is an electrodeless lamp.

### SUMMARY OF THE INVENTION

Therefore, with the foregoing in mind, it is a main object of the present invention to provide a mercury-free metal halide lamp having a small arc width.

A mercury-free metal halide lamp of the present invention includes an arc tube having a pair of electrodes opposed to each other inside the tube. In the arc tube, a rare gas and a halide of cerium are contained, and no mercury is contained.

In one embodiment, the mercury-free metal halide lamp of the present invention further includes at least one selected from the group consisting of a halide of scandium and a halide of sodium.

In one embodiment, the total amount of a halide enclosed in the arc tube is not more than 30 mg per cc of inner volume of the arc tube.

In one embodiment, the rated power of the mercury-free metal halide lamp is set to not less than 25 W and not more than 55 W.

In one embodiment, the rare gas includes at least Xe (xenon), and the pressure of the enclosed Xe is not less than 0.1 MPa and not more than 2.5 MPa at room temperature.

In one embodiment, the mercury-free metal halide lamp of the present invention further includes means for applying a magnetic field to the arc tube.

It is preferable that the mercury-free metal halide lamp of the present invention is a lamp for a point-like light source.

Another aspect of the present invention, a mercury-free metal halide lamp includes an arc tube having a pair of electrodes opposed to each other inside the tube, wherein the arc tube contains a rare gas, and at least one selected from the group consisting of a halide of cerium, a halide of zinc, a halide of aluminum, a halide of antimony, and indium bromide, and no mercury is contained.

According to the present invention, since a rare gas and a halide of cerium are contained in the arc tube having a pair of electrodes opposed to each other inside the tube, a mercury-free metal halide lamp having a small arc width can be provided.

This and other advantages of the present invention will become apparent to those skilled in the art upon reading and understanding the following detailed description with reference to the accompanying figures.

### BRIEF DESCRIPTION OF THE DRAWINGS

FIG. 1 is a schematic cross-sectional view showing the configuration of an electrode-provided metal halide lamp containing no mercury of an embodiment of the present invention.

FIG. 2 is a schematic view showing the configuration of an apparatus for measuring the arc width and the intensity.

FIG. 3 is a graph showing the intensity distribution of the arc.

FIG. 4 is a graph showing the relationship between the arc width and the maximum intensity of the lamp.

FIG. 5 is a graph showing the relationship between the efficiency and the voltage of the lamp.

FIG. 6 is a graph showing the relationship between the total amount of a halide of scandium enclosed and a halide of sodium enclosed and the luminous flux.

FIG. 7 is a graph showing the relationship between the amount of a halide of cerium enclosed and the lamp voltage.

FIG. 8 is a graph showing the relationship between the amount of a halide of zinc enclosed and the lamp voltage.

FIG. 9 is a graph showing the relationship between the amount of a halide of aluminum enclosed and the lamp voltage.

FIG. 10 is a graph showing the relationship between the amount of a halide of antimony enclosed and the lamp voltage.

FIG. 11 is a graph showing the relationship between the amount of a bromide of indium enclosed and the lamp voltage FIG. 12 is a schematic cross-sectional view showing the configuration in which a magnetic field applying means 8 is provided in the mercury-free metal halide lamp of this embodiment.

### DETAILED DESCRIPTION OF THE INVENTION

The inventors of the present invention made in-depth study to develop an electrode-provided mercury-free metal halide lamp having a small arc width, and succeeded in completing such a mercury-free metal halide lamp.

Hereinafter, embodiments of the present invention will be described with reference to the accompanying drawings. For simplification, elements having substantially the same function bear the same reference numeral. The present invention is not limited to the following embodiments.

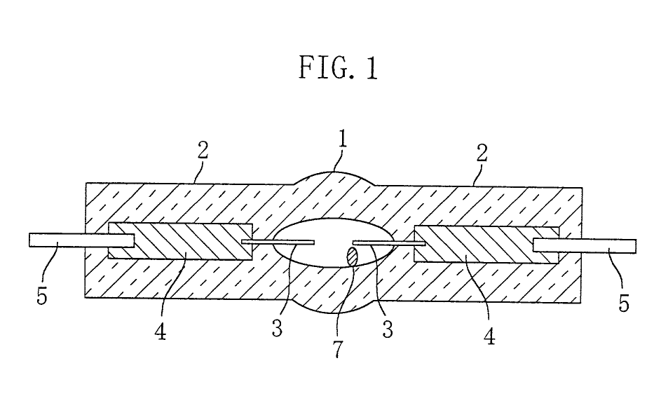

A mercury-free metal halide lamp of an embodiment of the present invention will be described. FIG. 1 is a schematic cross-sectional configuration of a mercury-free metal halide lamp of this embodiment.

The lamp of this embodiment includes an arc tube (bulb) 1 having a pair of electrodes (3,3) opposed to each other inside the tube. A pair of sealing portions 2 to achieve airtightness of the arc tube 1 extends from the arc tube 1. The electrode 3 is connected to a lead wire 5 made of molybdenum via a metal foil 4 in the sealing portion 2. In other words, the electrode 3 is electrically connected to one end of the molybdenum foil 4 sealed by the sealing portion 2, and electrically connected to the lead wire 5 connected to the other end of the molybdenum foil 4.

The electrode 3 is a tungsten electrode (the diameter of the electrode rod is about 0.25 mm) made of tungsten, and the head of the electrode 3 is arranged in the arc tube 1 such that the distance between the heads thereof (i.e., electrode distance) is about 3.7 mm. The arc tube 1 is made of quartz glass, and the inner volume of the arc tube 1 is about 0.025 cc. In the arc tube 1, a halide 7 comprising about 0.2 mg of cerium iodide (CeI₃), about 0.19 mg of scandium iodide (ScI₃), and about 0.16 mg of sodium iodide (NaI), and xenon gas (Xe) at 1.4 MPa are enclosed. However, mercury is not enclosed in the arc tube 1.

This lamp is turned on while the straight line connecting the electrodes is substantially horizontal, that is, horizontally operated. The lamp can be vertically operated or obliquely operated. In this embodiment, the operating power is 35 W. A large difference in the configuration between the conventional electrode-provided metal halide lamp and the metal halide lamp of this embodiment is that the metal halide lamp of this embodiment contains no mercury.

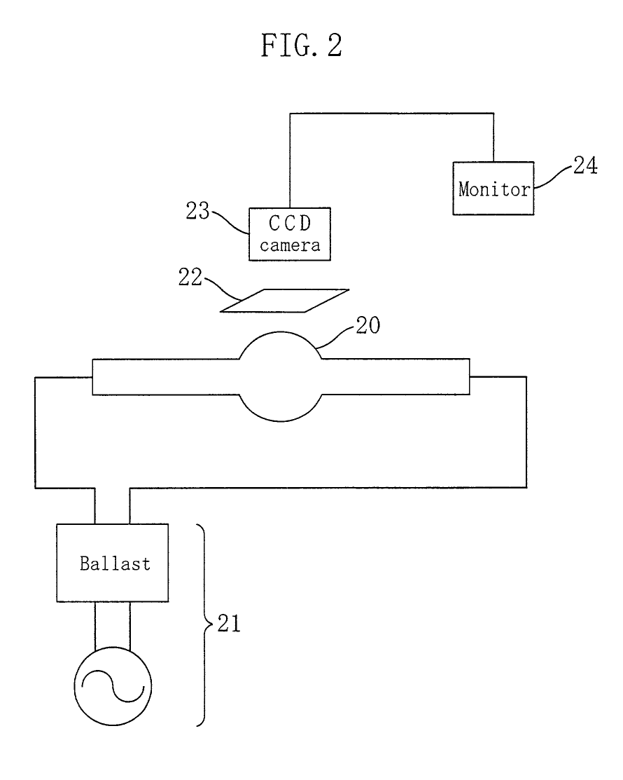

Surprisingly, the electrode-provided mercury-free metal halide lamp in this embodiment has a small arc width and a high intensity, although this is a lamp enclosing cerium halide. Hereinafter, a method for measuring the arc width and the arc intensity will be described with reference to FIG. 2.

FIG. 2 is a schematic view showing the configuration of a measurement apparatus for measuring the arc width and the arc intensity. A lamp 20 to be measured is electrically connected to a ballast for operating the lamp and a power supply (21). A CCD camera 23 captures an image of the arc of the lamp 20 through a filter 22 provided in the vicinity of the arc tube of the lamp 20, and the image captured by the CCD camera 23 is projected on a monitor 24.

The width of the arc was measured according to the Japan Electric Lamp Manufacture Association Standard (JEL215) of HID light sources for headlights of automobiles. The arc width defined by the Japan Electric Lamp Manufacture Association Standard (JEL215) is a width between the positions at a value of 20% of the maximum intensity when the relative intensity distribution of the arc is measured in the cross section of the center of the arc (the central position between the electrodes).

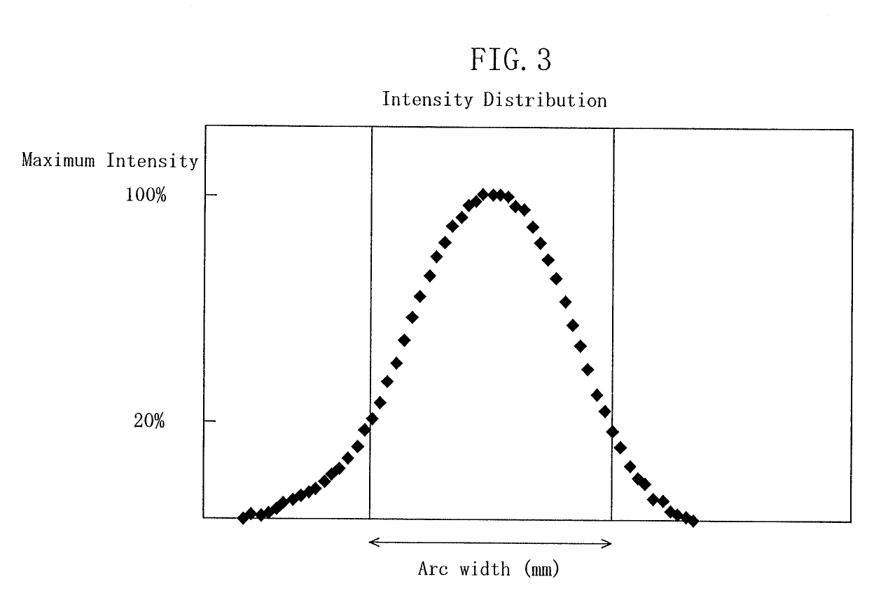

FIG. 3 shows an example of the intensity distribution of the arc. The vertical axis of FIG. 3 shows the ratio with respect to the maximum intensity, and the horizontal axis shows the arc position. In general, in the intensity of the arc, the maximum intensity is in the center of the arc in the cross section (central position between the electrodes), and the intensity distribution is substantially symmetric with the center of the arc in the cross section (central position between the electrodes) as the center.

In the method described above, the maximum intensity value and the arc width of the lamp of this embodiment were measured

Table 1 shows a list of the enclosed materials of the lamps measured by the inventors of the present invention.

TABLE 1

| | Enclosed materials |
|---|---|
| Lamp 1 | ScI₃(0.19 mg) NaI(0.16 mg) CeI₃(0.2 mg) |
| Lamp 2 | ScI₃(0.19 mg) NaI(0.16 mg) CeI₃(0.2 mg) Hg(0.65 mg) |
| (Coin. Ex.) | |
| Lamp 3 | ScI₃(0.03 mg) NaI(0.02 mg) ZnI₂(0.1 mg) |
| Lamp 4 | ScI₃(0.03 mg) NaI(0.02 mg) AlI₃(0.1 mg) |
| Lamp 5 | ScI₃(0.03 mg) NaI(0.02 mg) SbI₃(0.1 mg) |
| Lamp 6 | ScI₃(0.19 mg) NaI(0.16 mg) InBr(0.2 mg) |
| Lamp 7 | ScI₃(0.19 mg) NaI(0.16 mg) InBr(0.2 mg) CeI₃(0.2 mg) |

A lamp 1 is a mercury-free metal halide lamp of this embodiment, and a lamp 2 is a conventional lamp (comparative example) obtained by adding 0.65 mg of mercury to the lamp 1. Lamps 3 to 7 are also mercury-free metal halide lamps of this embodiment that are free of mercury.

All of the lamps 3 to 5 contain 0.03 mg of ScI₃ and 0.02 mg of NaI, and 0.1 mg of an iodide of zinc (ZnI₂) is added for the lamp 3, 0.1 mg of an iodide of aluminum (AlI₃) is added for the lamp 4, and 0.1 mg of iodide of antimony (SbI₃) is added for the lamp 5. For the lamp 6, instead of CeI₃ of lamp 1, 0.2 mg of indium bromide (InBr) is enclosed. For the lamp 7, 0.2 mg of InBr is added to the lamp 1.

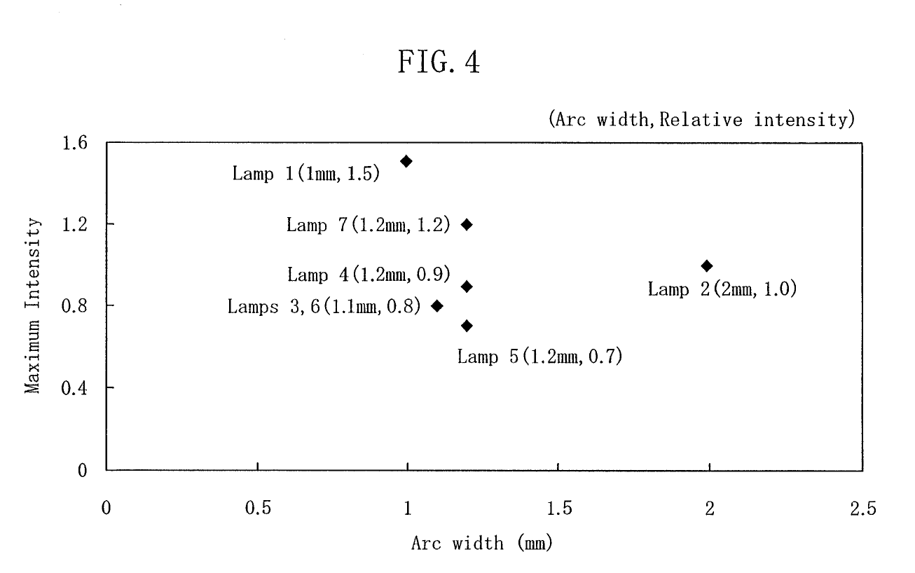

The inventors of the present invention made experiments with respect to the lamps 1 to 7 to examine the arc width and intensity characteristics. FIG. 4 shows the results. The vertical axis of FIG. 4 shows the maximum intensity of the lamp as a relative value when the maximum intensity of the lamp 2 (comparative example) is set to 1. The horizontal axis of FIG. 4 shows the arc width (mm). The lamp having a high intensity and a small arc width is a light source close to a point light source, and has excellent characteristics in that the efficiency of focusing light is improved when it is used in combination with a reflecting mirror or the like.

As seen from FIG. 4, the lamps 1 and 3 through 7 have an arc width smaller than that of the lamp 2 (comparative example). That is to say, the inventors of the present invention found that the arc width can be reduced by enclosing a halide of Ce, a halide of Zn, a halide of Al, a halide of Sb or indium bromide to a mercury-free lamp. As shown in FIG. 4, the arc width of the lamps 5, 4 and 7 is 1.2 mm, the arc width of the lamps 3 and 6 is 1.1 mm, and the arc width of the lamp 1 is 1.0 mm.

The lamps 1 and 7 have improved intensities, compared with the lamp 2 (comparative example). More specifically, the lamp 1 has an intensity of 1.5 times and the lamp 7 has an intensity of 1.2 times the intensity of the lamp 2 (comparative example). What is common to the lamps 1 and 7 is that both contain a halide of cerium. Therefore, a lamp having a small arc width and a high intensity can be realized by enclosing a halide of cerium in a mercury-free electrode-provided lamp.

Furthermore, the lamps 1 and 3 through 7, the lamp 8 enclosing only 0.19 mg of SCI₃ and 0.16 mg of NaI was measured with respect to the lamp voltage and the efficiency of emitted light. As understood easily, the lamp 8 is a lamp obtained by eliminating only CeI₃ from the lamp 1.

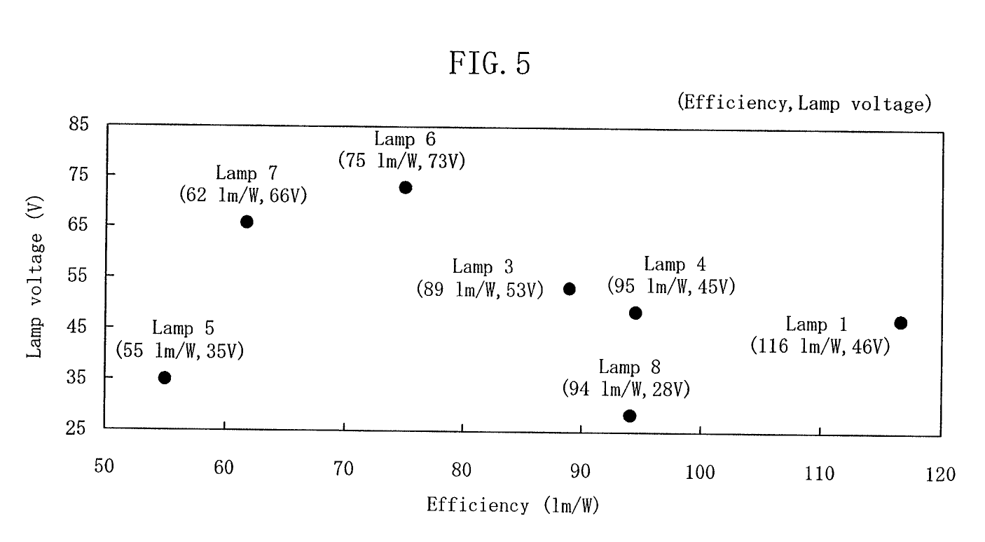

FIG. 5 shows the measurement results. As seen from FIG. 5, the lamp 1 shows the largest efficiency. To be specific, the lamp 1 enclosing cerium halide has a significantly high efficiency of 116 lm/W. Therefore, it is preferable to produce a lamp having the configuration of the lamp 1 to realize a lamp having a high efficiency. As for the lamp voltage, the lamp voltage of the lamp 8 is 28V, whereas the lamp voltages of the lamps 1 and 3 through 7 are higher than that. In other words, the lamp voltage can be increased by enclosing a halide of Ce, a halide of Zn, a halide of Al, a halide of Sb, or indium bromide. When the lamp voltage can be increased, it is possible to suppress the depletion of the electrodes because the current of the lamp can be reduced. When the lamp voltage can be increased, it is possible to operate the lamp with a small current, so that the operating circuit (ballast) can be small.

The effects found by the inventors of the present invention of achieving a small arc width and a high intensity by enclosing a halide of Ce in a mercury-free electrode-provided lamp can be obtained, regardless of other elements such as the lamp power, the distance between the electrodes, the inner volume of the art tube 1, the amount of an iodide of Sc or an iodide of Na, or the types or the amount of a halide enclosed other than a halide of Ce. Therefore, the present invention is not limited to these conditions. Furthermore, in order to obtain a small arc width, not only a mercury-free metal halide lamp enclosing a halide of Ce, but also a mercury-free metal halide lamp enclosing a halide of Zn, a halide of Al, a halide of Sb, or indium bromide can be used. However, in order to realize a lamp having a small arc width, a high intensity and a high efficiency, it is preferable to produce a lamp having the configuration of the lamp 1 of this embodiment.

Increasing the total amount of a halide enclosed tends to provide good characteristics to the lamp. For example, the lamp voltage can be raised by increasing the total amount of a halide enclosed. However, when a halide is enclosed in an amount exceeding 30 mg per unit inner volume (cc) of the arc tube is enclosed, a phenomenon occurs that the enclosed substance that is not evaporated comes up to the central portion of the arc tube along the wall of the arc tube during lamp operation as well. When this phenomenon occurs, the arc is hidden behind the enclosed substance that has come up, so that good characteristics cannot be exhibited. Therefore, it is preferable that the amount of a halide enclosed is 30 mg or less per unit inner volume (cc) of the arc tube.

In the lamp 1 of this embodiment, in addition to a halide of Ce, an iodide of Sc and an iodide of Na are enclosed. These halides are enclosed, mainly for the purpose of improving the luminous flux of the lamp.

It is preferable that the total amount of an iodide of Sc and an iodide of Na is 2 mg/cc or more and 15 mg/cc or less. When the lamp is turned on for a long time, an iodide of Sc or an iodide of Na reacts with glass or slips into the bases of the electrodes. As a result, the amount of the iodide that can emit is reduced. For this reason, it is preferable to enclose the iodide in an amount of 2 mg/cc or more.

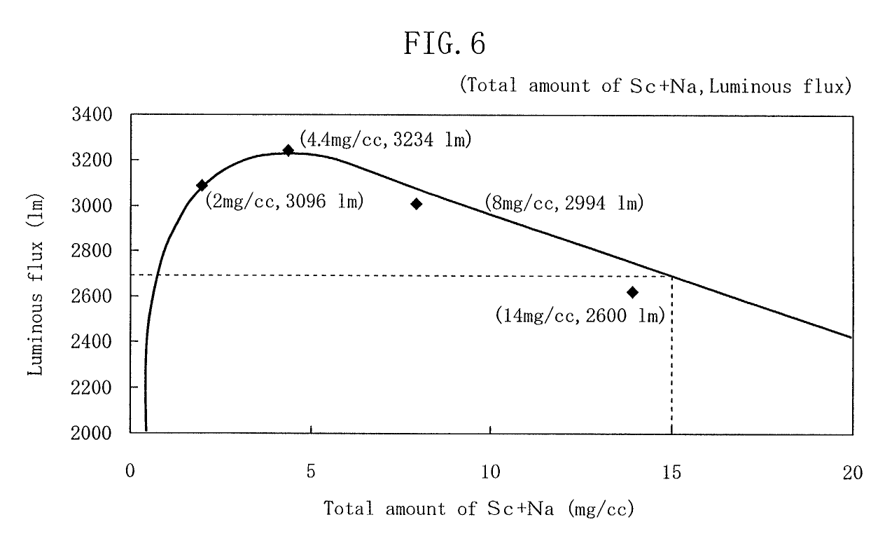

FIG. 6 shows the relationship between the total amount of scandium iodide and sodium iodide and the lamp luminous flux. The horizontal axis in FIG. 6 shows the total amount of scandium iodide and sodium iodide (the total amount of Sc+Na), and the vertical axis shows the luminous flux (lm) of the lamp. As shown in FIG. 6, when the total amount of the iodide of Sc and the iodide of Na is too much, emitted light is absorbed and the luminous flux is dropped. Therefore, it is preferable that the total amount of the iodide of Sc and the iodide of Na is below the predetermined amount. For example, when the amount is about 15 mg/cc or less, a luminous flux of about 2700 lm can be ensured. The Japan Electric Lamp Manufacture Standard of HID light sources for headlights of automobiles requires a luminous flux of the lamp of 2700 lm or more, and therefore it is preferable that the total amount of the iodide of Sc and the iodide of Na is 15 mg/cc or less, as long as it is used for headlights of automobiles.

When the luminous flux is required to be 2800 lm or more, it is preferable that the amount is 13 mg/cc or less. When the luminous flux is required to be 2600 lm or more, it is preferable that the amount is 16 mg/cc or less. When the luminous flux is required to be 2400 lm or more, it is preferable that the amount is 19 mg/cc or less.

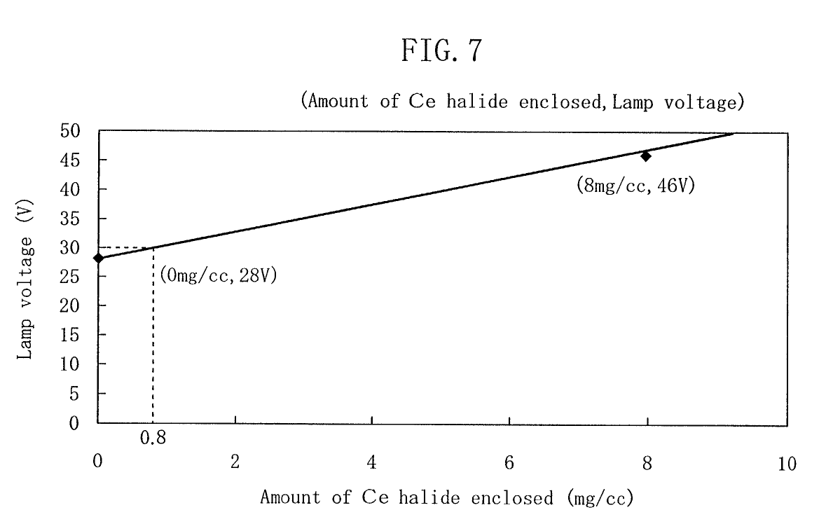

It is preferable that the amount of a halide of Ce enclosed is 0.8 mg/cc or more and 15 mg/cc or less. The reason for this will be described with reference to FIG. 7. The horizontal axis of FIG. 7 shows the amount of a halide of Ce per unit inner volume of the arc tube (mg/cc), and the vertical axis shows the lamp voltage (V).

As shown in FIG. 7, as the halide of Ce is enclosed in a larger amount, the lamp voltage is increased. When the lamp voltage is lower than 30V, the lamp current is increased, and the burden on the electrodes is increased, so that this is not practical. Therefore, it is preferable that the amount of a halide of Ce enclosed per unit inner volume of the arc tube is 0.8 mg/cc or more.

When the amount of a halide of Ce enclosed is increased, the luminous flux is increased and other advantages in the lamp characteristics are provided, so that it is preferable that the amount of a halide of Ce enclosed is comparatively large. However, when a halide of Ce in an amount of 15 mg/cc or more per unit inner volume of the arc tube is enclosed, the enclosed substance that is not evaporated comes up to the central portion of the arc tube along the wall of the arc tube during lamp operation as well. When this phenomenon occurs, the arc is hidden behind the enclosed substance, so that desired characteristics may not be exhibited. Therefore, it is preferable that the amount of a halide of Ce enclosed is 15 mg per unit inner volume (cc) of the arc tube.

Next, the amounts of other halide substances enclosed in the lamps 3 to 6 in this embodiment will be described.

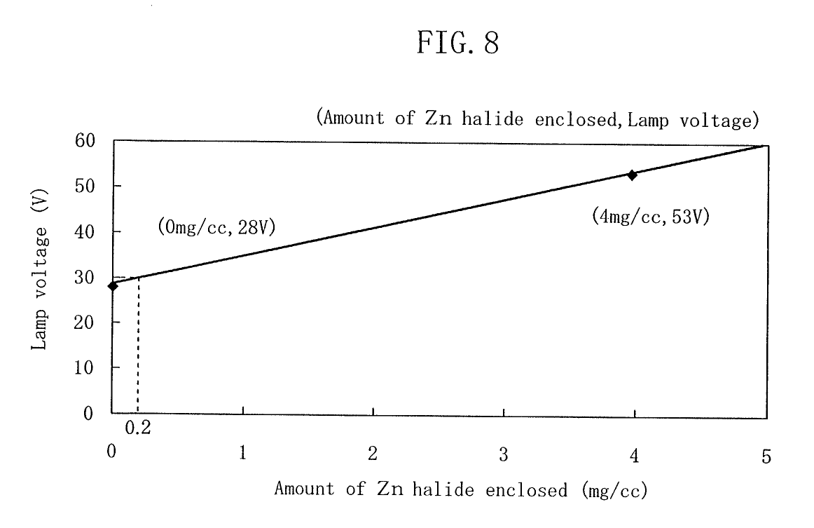

First, the lamp 3 will be described. For the lamp 3, it is preferable that the amount of a halide of Zn enclosed is 0.2 mg/cc or more and 15 mg/cc or less. The reason for this will be explained with reference to FIG. 8. The horizontal axis in FIG. 8 shows the amount of a halide of Zn per unit inner volume of the arc tube (mg/cc), and the vertical axis shows the lamp voltage (V).

As shown in FIG. 8, it is preferable that the amount of a halide of Zn enclosed is 0.2 mg/cc or more to achieve a lamp voltage of 30V or more. When the halide in an amount of 15 mg/cc or more per unit inner volume of the arc tube is enclosed, the enclosed substance that is not evaporated comes up to the central portion of the arc tube along the wall of the arc tube during lamp operation as well. When this phenomenon occurs, the arc is hidden behind the enclosed substance, so that desired characteristics may not be exhibited. Therefore, it is preferable that the amount of a halide of Zn enclosed is not more than 15 mg per unit inner volume (cc) of the arc tube.

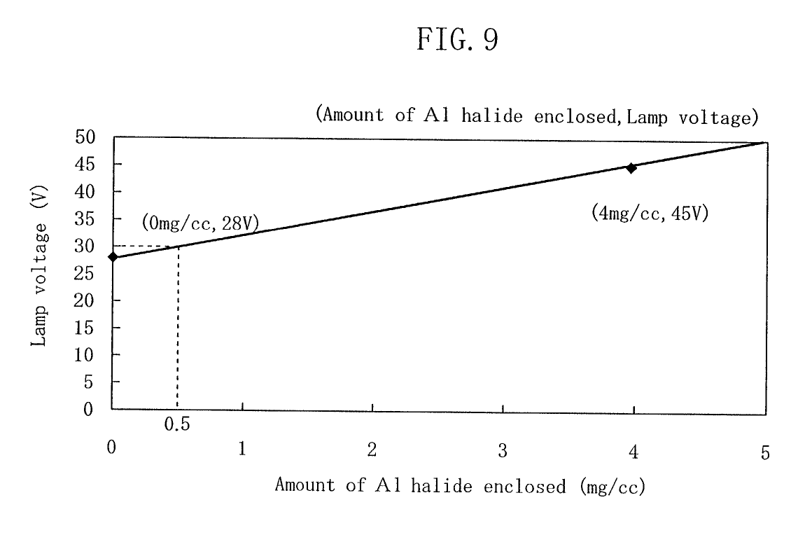

Next, the lamp 4 will be described. For the lamp 4, it is preferable that the amount of a halide of Al enclosed is 0.5 mg/cc or more and 15 mg/cc or less. The reason for this will be explained with reference to FIG. 9. The horizontal axis in FIG. 9 shows the amount of a halide of Al per unit inner volume of the arc tube (mg/cc), and the vertical axis shows the lamp voltage (V).

As shown in FIG. 9, it is preferable that the amount of a halide of Al enclosed is 0.5 mg/cc or more to achieve a lamp voltage of 30V or more. When the halide in an amount of 15 mg/cc or more per unit inner volume of the arc tube is enclosed, the enclosed substance that is not evaporated comes up to the central portion of the arc tube along the wall of the arc tube during lamp operation as well. When this phenomenon occurs, the arc is hidden behind the enclosed substance, so that desired characteristics may not be exhibited. Therefore, it is preferable that the amount of a halide of Al enclosed is not more than 15 mg per unit inner volume (cc) of the arc tube.

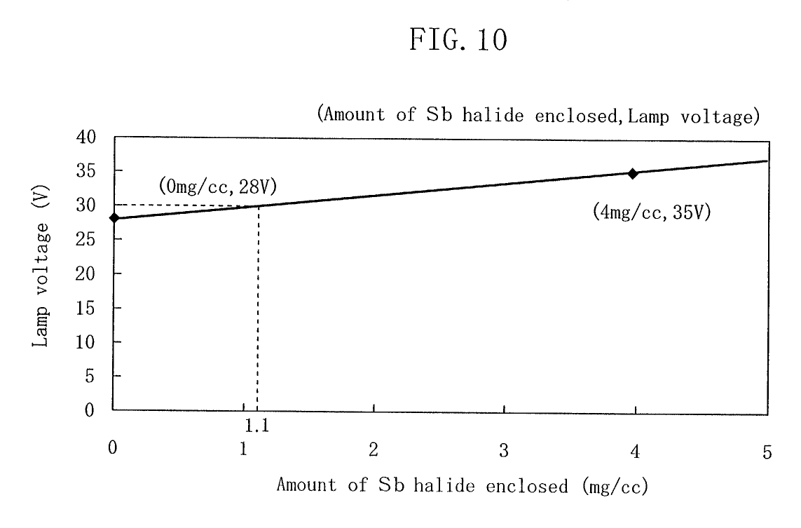

Next, the lamp 5 will be described. For the lamp 5, it is preferable that the amount of a halide of Sb enclosed is 1.1 mg/cc or more and 15 mg/cc or less. The reason for this will be explained with reference to FIG. 10. The horizontal axis in FIG. 10 shows the amount of a halide of Sb per unit inner volume of the arc tube (mg/cc), and the vertical axis shows the lamp voltage (V).

As shown in FIG. 10, it is preferable that the amount of a halide of Sb enclosed is 1.1 mg/cc or more to achieve a lamp voltage of 30V or more. When the halide in an amount of 15 mg/cc or more per unit inner volume of the arc tube is enclosed, the enclosed substance that is not evaporated comes up to the central portion of the arc tube along the wall of the arc tube during lamp operation as well. When this phenomenon occurs, the arc is hidden behind the enclosed substance, so that desired characteristics may not be exhibited. Therefore, it is preferable that the amount of a halide of Sb enclosed is not more than 15 mg per unit inner volume (cc) of the arc tube.

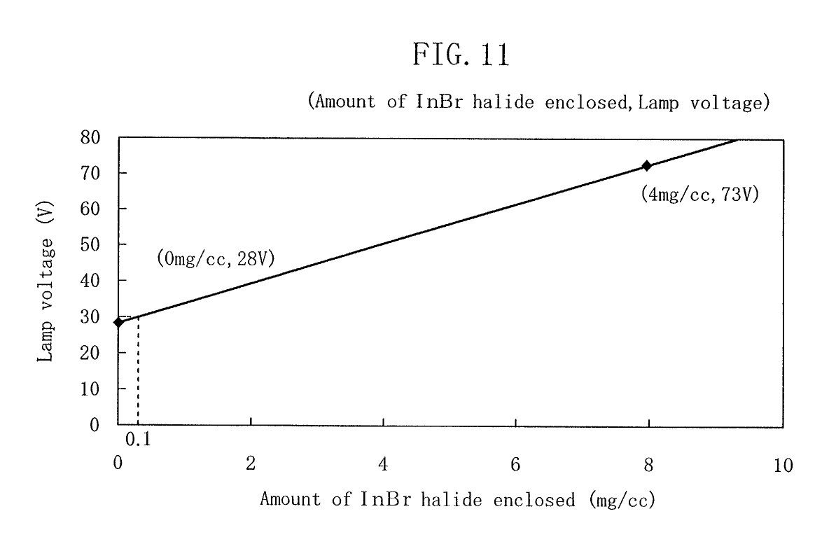

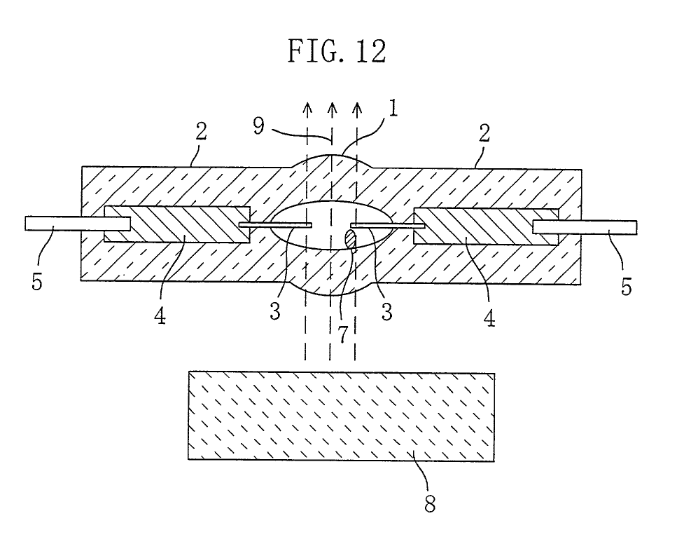

Next, the lamp 6 will be described. For the lamp 6, it is preferable that the amount of a halide of InBr enclosed is 0.1 mg/cc or more and 15 mg/cc or less. The reason for this will be explained with reference to FIG. 11. The horizontal axis in FIG. 11 shows the amount of a halide of InBr per unit inner volume of the arc tube (mg/cc), and the vertical axis shows the lamp voltage (V).

As shown in FIG. 11, it is preferable that the amount of a halide of InBr enclosed is 0.1 mg/cc or more to achieve a lamp voltage of 30V or more. When the halide in an amount of 15 mg/cc or more per unit inner volume of the arc tube is enclosed, the enclosed substance that is not evaporated comes up to the central portion of the arc tube along the wall of the arc tube during lamp operation as well. When this phenomenon occurs, the arc is hidden behind the enclosed substance, so that desired characteristics may not be exhibited. Therefore, it is preferable that the amount of a halide of InBr enclosed is not more than 15 mg per unit inner volume (cc) of the arc tube.

In the above-described configuration of this embodiment, when the lamp is operated with a lamp power of about 25 W or more, stable arc that sufficiently can keep the lamp on can be obtained. As the lamp is operated in a larger lamp power, a larger luminous flux can be obtained. However, in practice, about 55 W is sufficient as the upper limit of the power consumption of the lamp of this embodiment, as long as the lamp is used for headlights of automobiles. This is because the power consumption of a halogen lamp for headlights for automobiles is 55 W, and operation in a power of more than 55 W is uneconomical and not preferable. When such a use is desired, although it is uneconomical, the upper limit of the power consumption of the lamp can be more than 55 W.

Hereinafter, the pressure of Xe gas enclosed will be described. For an electrode-provided metal halide lamp containing no mercury of this embodiment, it is preferable to set the upper limit of the pressure of Xe gas enclosed to about 2.5 MPa (at room temperature) in order to produce a lamp suitable for practical use. When Xe gas is enclosed at about 2.5 MPa or more, in the configuration of the lamp of this embodiment, the possibility of losing airtightness inside the arc tube 1 from the vicinity of the connection portion of the electrodes 3 and the molybdenum foils 4 during operation becomes high, and therefore it is not preferable. More preferably, the upper limit of the pressure of Xe gas enclosed is about 2.0 MPa. However, it is more preferable that the lower limit is 0.1 MPa to use the lamp of this embodiment as a light source for headlights of automobiles for which a quick start of operation is required.

The lamp of this embodiment is susceptible to a force of convection current of gas generated by the temperature distribution of the arc tube because of a small arc width. Therefore, a phenomenon that the arc is curved is observed. In this context, as shown in FIG. 12, means 8 for applying a magnetic field 9 (e.g., permanent magnet) having a component vertical to a straight line connecting the electrodes 3 of the lamp may be provided in the vicinity of the lamp of this embodiment. When such a magnetic field 9 is applied, the curving of the arc can be suppressed. The principle that the arc curving can be suppressed by applying such a magnetic field 9 in a mercury-free metal halide lamp is not clear at present, but the parameters that can suppress the arc curving are disclosed in Japanese Patent Application No. 2000-388000 (corresponding to U.S. Ser. No. 09/739974, Applicant; Matsushita Electric Industrial Co., Ltd.) It is also found that when these parameters satisfy the relationship of Equations (1) and (2), not only the arc curving is suppressed, but also vibration of the arc can be suppressed, which is described in Japanese Patent Application No. 2001-155385 (Applicant; Matsushita Electric Industrial Co., Ltd.), which is incorporated herein by reference.

As for mercury-free metal halide lamp, Equations 1 and 2 showing the relationship of the arc curving suppression and the arc vibrations suppression are as follows.

0<(100BW/f)−P₀d<100 Equation 1

0<(10BW/f)−Pd<10 Equation 2

wherein B(mT) is the magnetic field (9) applied to a center between the heads of the pair of electrodes when the lamp is operated horizontally such that a straight line connecting the heads of the pair of electrodes (3, 3) is substantially horizontal, d(mm) is the distance between the heads of the pair of electrodes (3, 3), P₀(MPa) is the pressure inside the arc tube 1 during steady-state operation, w(w) is the power consumed during steady-state operation, and f(Hz) is the steady-state frequency during steady-state operation. P(MPa) in Equation 2 is the pressure of an enclosed rare gas at 20° C.

The meaning of each term of Equations 1 and 2 will be described briefly. The terms (100BW/f) in Equation 1 and (10BW/f) in Equation 2 are the terms of the downward force on the arc generated by the magnetic field 9, and the term P₀d in Equation 1 and Pd in Equation 2 are the terms of the upward force (buoyancy) on the arc generated by the convection current of the gas in the arc tube.

Because of the fact that the pressure P of the enclosed rare gas can be measured more easily than the operating pressure P₀ and because there is no particular problem in specifying the configuration, not with the operating pressure P₀, but with the pressure P of the enclosed rare gas, it is much more advantageous for the lamp design to specify the configuration according to Equation 2. In Equation 2, more preferable conditions are as follows. It is preferable that P satisfies 0.1(MPa)<P<2.5(MPa). It is preferable that P·d satisfies P·d<8 (more preferably Pd≦4.6). Moreover, it is preferable that f satisfies 40(Hz)<f. It is preferable that B satisfies B<500(mT). It is preferable that d satisfies 2<d(mm).

In a lamp having a small inner diameter of the arc tube 1, for example, of 5 mm or less, the arc curving significantly affects especially the lifetime characteristics or the like. More specifically, the arc curving raises the temperature of the upper portion of the arc tube 1, and opaqueness of the quartz glass, which is the material of the arc tube, occurs or other malfunction occurs, resulting in short lifetime of the lamp. Therefore, it seems that suppressing the arc curving with the force of the magnetic field 9 is effective means to improve the quality of the lamp such as lifetime characteristics. Furthermore, vibrations of the arc is not preferable because it may cause flickering, so that suppressing vibrations of the arc leads to improvement in the lamp characteristics.

The magnetic field 9 necessary to suppress the arc curving is varied with the design of the lamp, so that it is preferable to apply the magnetic field 9 suitable for each lamp. However, it is significantly advantageous to define each parameter such that the relationships of Equations 1 and 2 are satisfied, because a lamp in which the arc curving and vibrations of the arc can be suppressed can be designed easily without trial and error. As this means 8 for applying a magnetic field, a permanent magnet (e.g., ferrite permanent magnet) is preferable because the magnetic field can be applied in a simple manner. The means 8 for applying a magnetic field can be an electromagnet.

The means 8 for applying a magnetic field is used to suppress the arc curving and vibrations of the arc, and the effect of this embodiment that enclosing a halide of Ce in a mercury-free electrode-provided lamp achieves a small arc width and a high intensity can be obtained without the means 8 for applying a magnetic field. Moreover, the effect of this embodiment that enclosing a halide of Ce, a halide of Zn, a halide of Al, a halide of Sb or indium bromide also achieves a small arc width and a high intensity can be obtained without the means 8 for applying a magnetic field.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A mercury-free metal halide lamp comprising an arc tube having a pair of electrodes opposed to each other inside the tube,
wherein in the arc tube, a rare gas and a halide of cerium are contained and no mercury is contained.

2. The mercury-free metal halide lamp according to claim 1, further comprising at least one selected from the group consisting of a halide of scandium and a halide of sodium.

3. The mercury-free metal halide lamp according to claim 2, wherein a total amount of a halide enclosed in the arc tube is not more than 30 mg per cc of inner volume of the arc tube.

4. The mercury-free metal halide lamp according to claim 1, wherein a rated power of the mercury-free metal halide lamp is set to not less than 25 W and not more than 55 W.

5. The mercury-free metal halide lamp according to claim 1, wherein the rare gas comprises at least Xe (xenon) and
a pressure of t he enclosed Xe is not less than 0.1 MPa and not more than 2.5 MPa at room temperature.

6. The mercury-free metal halide lamp according to claim 1, further comprising means for applying a magnetic field to the arc tube.

7. The mercury-free metal halide lamp according to claim 1, which is a lamp for a point-like light source.

8. A mercury-free metal halide lamp comprising an arc tube having a pair of electrodes opposed to each other inside the tube,
wherein the arc tube contains:
a rare gas, and
at least one selected from the group consisting of a halide of cerium, a halide of zinc, a halide of aluminum, a halide of antimony, and indium bromide, and
no mercury is contained.
